(19) United States
(12) Patent Application Publication
(10) Pub. No.: US 2004/0263513 A1
(43) Pub. Date: Dec. 30, 2004

(54) Treemap visualization engine

(76) Inventors: Marc A. Smith, Redmond, WA (US); Duncan L. Davenport, Kirkland, WA (US); Tony Capone, Seattle, WA (US)

Correspondence Address: IPSOLON LLP, 805 SW BROADWAY, #2740, PORTLAND, OR, 97205, US

(21) Appl. No.: 10/608,878

(22) Filed: Jun. 26, 2003

(51) Int. Cl. G06T 11/20

(52) U.S. Cl. 345/440

(57) ABSTRACT

A treemap visualization generator provides treemap visualizations of arbitrary hierarchical data or data structures. The treemaps can be rendered as static images in various formats or can be displayed in applications that provide user interaction, such as zooming into smaller areas of the overall hierarchy. The treemap visualization engine includes a treemap generator object that receives an arbitrary set of hierarchical data from a caller resource and draws a treemap representation of the data onto an object provided by the caller resource. A treemap control object displays the treemap representation in an application. The treemap generator object and the treemap control object include various interfaces that are defined by methods and properties.

### TECHNICAL FIELD

The present invention relates to providing treemap visualizations of hierarchical or nested data and, in particular, to a treemap visualization engine for providing treemap visualizations of arbitrary hierarchical or nested data.

### BACKGROUND AND SUMMARY

A visualization technique known as tree maps, or treemaps, was developed in the early 1990's to represent hierarchical data as nested boxes of sizes proportional to some aspect of each data node. The treemap visualization technique was introduced in the article: Tree-Maps: A Space-Filling Approach to the Visualization of Hierarchical Information Structures,” B. Johnson, B. Shneiderman, Proceedings-Visualization '91, October 22-14 25, 1991-IEEE Computer Society Press, pp. 284-290.

Tree maps have been used to represent a variety of hierarchical or nested data and data structures (collectively referred to herein as hierarchical data). Generally, each described use of a treemap visualization is directed to a specific application with a specific type of hierarchical data.

An aspect of the present invention is an appreciation that a generalized treemap visualization generator could be applied to virtually arbitrary hierarchical data or data structures. The present invention includes a treemap visualization generator for providing treemap visualizations of arbitrary hierarchical data. The treemaps can be rendered as static images in various formats or can be displayed in an application that provides for user interaction, such as zooming into smaller areas of the overall hierarchy. For example, the application may be a browser application that runs within a browser or a rich client application that does not run within a browser. In one implementation, the treemaps are displayed in a Windows Forms rich client application that employs the Widows Forms application model promulgated by Microsoft Corporation.

In one implementation, the treemap visualization engine includes a treemap generator object that receives an arbitrary set of hierarchical data from a caller resource and draws a treemap representation of the data onto an object provided by the caller resource. A treemap control object displays the treemap representation in its own window within an application, for example. The treemap generator object and the treemap control object include various interfaces that are defined by methods and properties. For example, the treemap generator object includes a TreemapGenerator interface having a property that receives the set of hierarchical data as an XML string to form a collection of treemap Node objects.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is an illustration of a prior art treemap visualization for representing hierarchical data.

FIG. 2 is a block diagram of a treemap visualization engine for generating treemap visualizations from arbitrary hierarchical data.

### DETAILED DESCRIPTION OF PREFERRED EMBODIMENTS

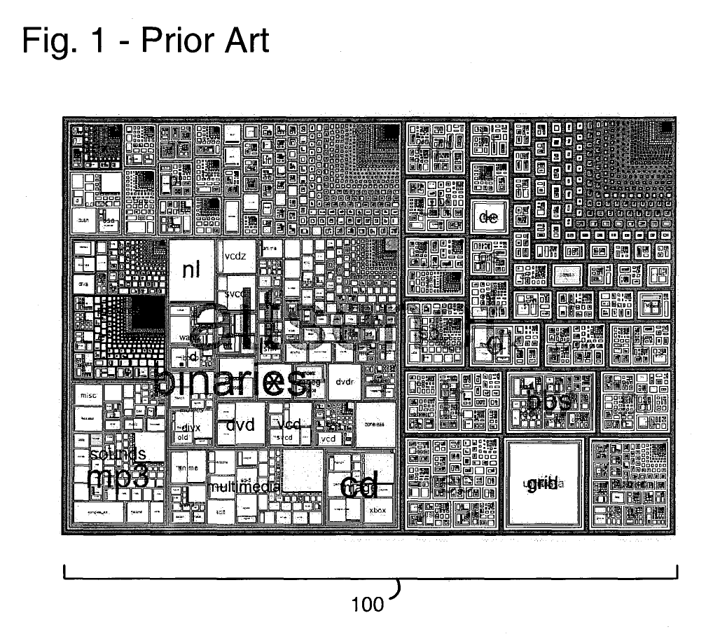

FIG. 1 is an illustration of a prior art treemap visualization 100 for representing hierarchical data as nested boxes of sizes proportional to some aspect of each data node. In particular, treemap visualization 100 illustrates hierarchical relationships of newsgroups in the Usenet, a portion of the Internet. The relative sizes of the boxes are based on the number of posts per newsgroup over a one-month period.

It will be appreciated that treemap visualizations may be applied to any type of hierarchical or nested information, not just hierarchical relationships of newsgroups in the Usenet. Examples include the amounts of information in different types of computer file systems (e.g., databases, email folders, file server directories, etc.), population census information, inventory or resource listings, etc.

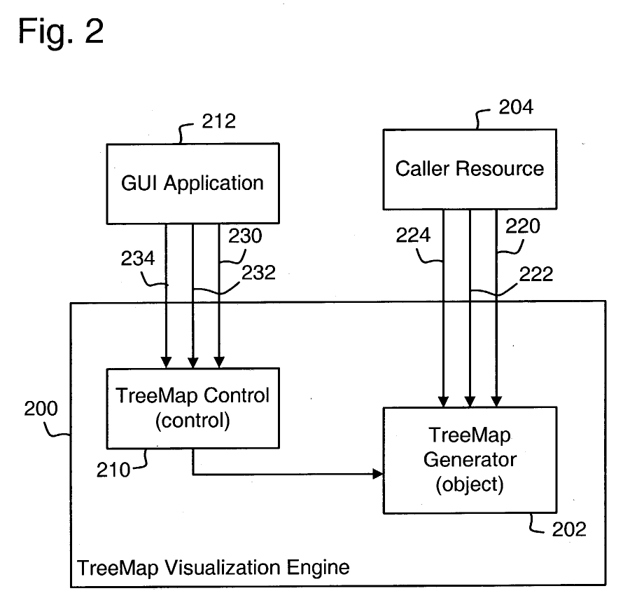

FIG. 2 is a block diagram of a treemap visualization engine 200 for generating treemap visualizations from arbitrary hierarchical or nested data (including hierarchical or nested data structures). Treemap visualization engine 200 provides a general purpose, object-based tool that is compatible with the wide variety of hierarchical or nested information types that can be represented with treemap visualizations. In contrast, prior treemap generators conventionally were adapted specifically for a particular hierarchical data type and were unable to accommodate other data types.

Treemap visualization engine 200 includes a treemap generator 202, which functions as a drawing engine that takes a set of hierarchical or nested data from a caller resource 204 and draws a treemap representation of the data. The directional lead lines in FIG. 2 point toward features (e.g., treemap generator 202) that are made use of by features at the bases of the lead lines (e.g., caller resource 204).

Caller resource 204 may be any source of hierarchical or nested data, such as email system folder contents, file directory contents, a server-side Web application, or any other hierarchical data representing any type of information, whether or not computer-related. Treemap generator 202 creates from the hierarchical data a corresponding treemap visualization, such as treemap visualization 100 (FIG. 1). In one implementation, treemap generator 202 does not have its own user interface. As a result, treemap generator 202 draws on a surface or object provided by caller resource 204. This allows treemap generator 202 to be used in a variety of environments, including server-side Web pages that create images for downloading to browsers, for example.

Treemap visualization engine 200 further includes a treemap control 210 for displaying treemaps generated by treemap visualization engine 200 in an application 212 that can provide user interaction, such as zooming into one of the treemap's boxes. For example, application 212 may be a browser application that runs within a browser or a rich client application that does not run within a browser. In one implementation, application 212 is a Windows Forms rich client application that employs the Widows Forms application model promulgated by Microsoft Corporation.

It will be appreciated that treemap generator 202 is operable alone without treemap control 210 to provide treemap visualizations for arbitrary hierarchical data. In this mode of operation, treemap visualizations formed by treemap generator 202 are returned to caller resource 204. Treemap generator 202 does not have a user interface of its own.

Treemap generator 202 is implemented in an object-based format to provide to caller resource 204 as public interfaces a treemap generator interface 220, a nodes interface 222, and a node interface 224. Table 1 lists properties and methods included in treemap generator interface 220. Table 2 lists properties and methods included in nodes interface 222. Table 3 lists properties included in node interface 224.

TABLE 1
Treemap Generator interface
TreemapGenerator Properties

| | |
|---|---|
| BackColor | Gets or sets the treemap's background color. |
| BorderColor | Gets or sets the color of rectangle borders. |
| DiscreteNegativeColors | Gets or sets the number of discrete fill colors to use in |
| | the negative color range. |
| DiscretePositiveColors | Gets or sets the number of discrete fill colors to use in |
| | the positive color range. |
| FontFamily | Gets or sets the font family to use for drawing node |
| | text. |
| FontSolidColor | Gets or sets the color to use for node text. |
| MaxColor | Gets or sets the maximum positive fill color. |
| MaxColorMetric | Gets or sets the ColorMetric value to map to MaxColor. |
| MinColor | Gets or sets the maximum negative fill color. |
| MinColorMetric | Gets or sets the ColorMetric value to map to MinColor. |
| NodeLevelsWithText | Gets or sets the node levels to show text for. |
| Nodes | Gets the collection of top-level Node objects. |
| NodesXml | Gets or sets the entire nested node hierarchy as an |
| | XML string. |
| PaddingDecrementPerLevelPx | Gets or sets the number of pixels that is subtracted |
| | from the padding at each node level. |
| PaddingPx | Gets or sets the padding that is added to the |
| | rectangles for top-level nodes. |
| PenWidthDecrementPerLevelPx | Gets or sets the number of pixels that is subtracted |
| | from the pen width at each node level. |
| PenWidthPx | Gets or sets the pen width that is used to draw the |
| | rectangles for the top-level nodes. |

TreemapGenerator Methods

| | |
|---|---|
| ClearNodes | Removes all nodes from the Nodes collection. |
| Draw | Draws the treemap onto the entire rectangle of a |
| | Bitmap. |
| Draw | Draws the treemap onto a specified rectangle of a |
| | Bitmap. |
| Draw | Draws the treemap onto a Graphics object. |
| Draw | Draws the treemap using owner-implemented code. |
| GetFontAlphaRange | Gets the range of transparency used for drawing node |
| | text. |
| GetFontSizeRange | Gets the range of font sizes used for drawing node |
| | text. |
| GetNodeFromPoint | Gets the Node object containing a specified PointF. |
| GetNodeFromPoint | Gets the Node object containing a specified coordinate |
| | pair. |
| GetNodeLevelsWithTextRange | Gets the range of node levels for which text is shown. |
| SelectNode | Selects a node. |
| SetFontAlphaRange | Sets the range of transparency used for drawing node |
| | text. |
| SetFontSizeRange | Sets the range of font sizes used for drawing node |
| | text. |
| SetNodeLevelsWithTextRange | Sets the range of node levels for which text is |
| | displayed. |

TreemapGenerator Events

| | |
|---|---|
| DrawItem | Occurs during owner drawing. |

TABLE 2
Nodes interface
Nodes Properties

| | |
|---|---|
| Count | Gets the number of objects in the collection. |
| EmptySpace | Gets the object that represents empty space in the |
| | parent rectangle. |
| Item | Gets the object at the specified index. |
| RecursiveCount | Gets the number of objects in the collection, |
| | including all descendant objects. |

Nodes Methods

| | |
|---|---|
| Add | Adds an existing Node object to the end of a Nodes |
| | collection. |
| Add | Creates a Node object with the specified text, size |
| | metric, and color metric, and adds it to the end of |
| | a Nodes collection. |
| Add | Creates a Node object with the specified text, size |
| | metric, color metric, and tag, and adds it to the end |
| | of a Nodes collection. |
| Add | Creates a Node object with the specified text, size |
| | metric, color metric, tag, and tooltip, and adds it to the |
| | end of a Nodes collection. |

TABLE 3
Node interface

Node Properties

| | |
|---|---|
| ColorMetric | Gets or sets the metric that determines the fill color of |
| | the node's rectangle. |
| Nodes | Gets the collection of child Node objects. |
| SizeMetric | Gets or sets the metric that determines the size of |
| | the node's rectangle. |
| Tag | Gets or sets the arbitrary object associated with |
| | the node. |
| Text | Gets or sets the node's text. |
| ToolTip | Gets or sets the node's tooltip. (Used by |
| | TreemapControl, not TreemapGenerator.) |

Treemap generator 202 receives from caller resource 204 a collection of nested Node objects, where each Node represents one box in the treemap. A TreemapGenerator.Nodes property of treemap generator interface 220 exposes the collection of top-level nodes. In association with the collection, a Nodes.Count property of nodes interface 222 returns the number of items in the collection, and a Nodes.Item property returns the Node object with the specified index. The Nodes.Add( ) methods of interface 222 add a node to the end of the collection. Methods with the same name differ by the arguments they accept, as indicated in the tables.

Each Node object has a Text property that determines the text displayed in the box, a ColorMetric property that determines a fill color for the box, a SizeMetric property that determines a size for the box relative to other boxes at the same level, and a Nodes property that exposes child nodes of a node. There is also a Tag property that caller resource 204 can use to associate an arbitrary object with the Node. The Tag exists for the convenience of caller resource 204 and is not used by treemap generator 202.

A caller resource 204 can populate a Nodes collection of treemap generator 202 by making repeated calls to the Nodes.Add( ) method. As an alternative, the entire collection can be set in one step using the TreemapGenerator.NodesXml property. The string passed to this property is in the eXtensible Mark-up Language (XML) and is constrained to have the following format:

```
<?xml version=“1.0” encoding=“utf-16”?>
<Nodes EmptySizeMetric=“”
xmlns:xsd=“http://www.w3.org/2001/XMLSchema”
xmlns:xsi=“http://www.w3.org/2001/XMLSchema-instance”>
  <Node Text=“TopLevel1” SizeMetric=“” ColorMetric=“” ToolTip=“”>
    <Nodes EmptySizeMetric=“”>
      <Node Text=“Child1” SizeMetric=“” ColorMetric=“”
      ToolTip=“”>
        <Nodes EmptySizeMetric=“”>
          <Node Text=“Grandchild1” SizeMetric=“” ColorMetric=“”
ToolTip=“”>
            <Nodes EmptySizeMetric=“”/>
          </Node>
          <Node Text=“Grandchild2” SizeMetric=“” ColorMetric=“”
ToolTip=“”>
            <Nodes EmptySizeMetric=“”/>
          </Node>
      ...
        </Nodes>
      </Node>
      <Node Text=“Child2” SizeMetric=“” ColorMetric=“”
      ToolTip=“”>
        <Nodes EmptySizeMetric=“”/>
      </Node>
    ...
    </Nodes>
  </Node>
  <Node Text=“TopLevel2” SizeMetric=“” ColorMetric=“” ToolTip=“”>
    <Nodes EmptySizeMetric=“”/>
  </Node>
  ...
</Nodes>
```

An application can populate the treemap using the Nodes.Add( ) methods, then read the NodesXml property and save the XML string to a permanent storage medium, such as a file in a file system. The application can later repopulate the treemap by retrieving the saved XML and passing it to the NodesXml property.

There is one <Node> element for each treemap node specified in the XML string. The element has Text, SizeMetric, ColorMetric, and ToolTip attributes. SizeMetric is a floating-point number greater than 0. ColorMetric is any floating-point number. The ToolTip attribute is text that is shown in a popup box when the user hovers the mouse over the node's box, as described below in greater detail.

Each <Node> element has a child <Nodes> element that contains the child nodes of the <Node> element. An empty <Nodes/> element is included if a treemap node has no children. The <Nodes> element has a floating-point EmptySizeMetric attribute that indicates how much empty space to include in the upper-right corner of the box corresponding to the parent node.

Treemap generator 202 has a set of properties that determine how Node.ColorMetric values map to displayed-colors. Another set of properties determine box attributes such as line widths and box spacing. Once it has populated a Nodes collection with hierarchical data, caller resource 204 can call one of theTreemapGenerator.Draw( ) methods to draw a treemap representation of the data. The Draw( ) methods accept a Graphics or Bitmap object provided by caller resource 204. The Draw( ) methods can be used to display the treemap in various ways, including displaying it on a display screen, showing a print preview, drawing to the printer, drawing to a bitmap that will be saved to a file, and so on.

A SelectNode( ) method redraws the box corresponding to a specified node to show that it is selected. If another box was already selected, that box is redrawn as unselected. A pair of TreemapGenerator.GetNodeFromPoint( )methods find the box that contains a specified point and return a Node object corresponding to that box. Caller resource 204 can use this for hit-testing while processing mouse events.

Treemap control 210 provides application 212 with a treemap control interface 230, a nodes interface 232, and a node interface 234. Table 4 lists properties and methods included in treemap control interface 230. Table 5 lists properties and methods included in nodes interface 232. Table 3 lists properties included in node interface 234.

TABLE 4
TreemapControl interface
TreemapControl Properties

| | |
|---|---|
| BackColor | Gets or sets the treemap's background color. |
| Bitmap | Gets the control's internal Bitmap. |
| BorderColor | Gets or sets the color of rectangle borders. |
| DiscreteNegativeColors | Gets or sets the number of discrete fill colors to use in |
| | the negative color range. |
| DiscretePositiveColors | Gets or sets the number of discrete fill colors to use in |
| | the positive color range. |
| FontFamily | Gets or sets the font family to use for drawing node |
| | text. |
| FontSolidColor | Gets or sets the color to use for node text. |
| MaxColor | Gets or sets the maximum positive fill color. |
| MaxColorMetric | Gets or sets the ColorMetric value to map to MaxColor. |
| MinColor | Gets or sets the maximum negative fill color. |
| MinColorMetric | Gets or sets the ColorMetric value to map to MinColor. |
| NodeLevelsWithText | Gets or sets the node levels to show text for. |
| Nodes | Gets the collection of top-level Node objects. |
| NodesXml | Gets or sets the entire nested node hierarchy as an |
| | XML string. |
| PaddingDecrementPerLevelPx | Gets or sets the number of pixels that is subtracted |
| | from the padding at each node level. |
| PaddingPx | Gets or sets the padding that is added to the |
| | rectangles for top-level nodes. |
| PenWidthDecrementPerLevelPx | Gets or sets the number of pixels that is subtracted |
| | from the pen width at each node level. |
| PenWidthPx | Gets or sets the pen width that is used to draw the |
| | rectangles for the top-level nodes. |
| ShowToolTips | Gets or sets a value indicating whether tooltips should |
| | be shown. |

TreemapControl Methods

| | |
|---|---|
| ClearNodes | Removes all nodes from the Nodes collection. |
| Draw | Draws the treemap onto the control. |
| Draw | Draws the treemap onto a Graphics object. |
| GetFontAlphaRange | Gets the range of transparency used for drawing node |
| | text. |
| GetFontSizeRange | Gets the range of font sizes used for drawing node |
| | text. |
| GetNodeLevelsWithTextRange | Gets the range of node levels for which text is shown. |
| SelectNode | Selects a node. |
| SetFontAlphaRange | Sets the range of transparency used for drawing node |
| | text. |
| SetFontSizeRange | Sets the range of font sizes used for drawing node text. |
| SetNodeLevelsWithTextRange | Sets the range of node levels for which text is |
| | displayed. |

TreemapControl Events

| | |
|---|---|
| NodeDoubleClick | Occurs when the rectangle of a Node object is double- |
| | clicked. |
| NodeMouseDown | Occurs when the mouse pointer is over the rectangle of a |
| | Node object and a mouse button is pressed. |
| NodeMouseHover | Occurs when the mouse pointer hovers over the rectangle of |
| | a Node object. |
| NodeMouseUp | Occurs when the mouse pointer is over the rectangle of a |
| | Node object and a mouse button is released. |
| SelectedNodeChanged | Occurs when the selected node changes. |

The control fires a number of events that an implementing application can intercept. TreemapControl.NodeMouseHover is fired when the user hovers the mouse over a box. The Node object corresponding to the box is passed to the event handler. If the TreemapControl.ShowToolTips property is true, the control also shows the node's tooltip. TreemapControl.NodeMouseDown is fired when the user presses a mouse button while the mouse is over a box. The Node object corresponding to the box is passed to the event handler. The control also redraws the box to show that it is selected.

TreemapControl.NodeMouseUp is fired when the user releases a mouse button while the mouse is over a box.

TreemapControl.NodeDoubleClick is fired when the user double-clicks on a box. The Node object corresponding to the box is passed to the event handler.

In accordance with the practices of persons skilled in the art of computer programming, the present invention is described above with reference to acts and symbolic representations of operations that are performed by various computer systems and devices. Such acts and operations are sometimes referred to as being computer-executed and may be associated with the operating system or the application program as appropriate. It will be appreciated that the acts and symbolically represented operations include the manipulation by a CPU of electrical signals representing data bits, which causes a resulting transformation or reduction of the electrical signal representation, and the maintenance of data bits at memory locations in a memory system to thereby reconfigure or otherwise alter the computer system operation, as well as other processing of signals. The memory locations where data bits are maintained are physical locations that have particular electrical, magnetic, or optical properties corresponding to the data bits.

Having described and illustrated the principles of our invention with reference to an illustrated embodiment, it will be recognized that the illustrated embodiment can be modified in arrangement and detail without departing from such principles. In view of the many possible embodiments to which the principles of our invention may be applied, it should be recognized that the detailed embodiments are illustrative only and should not be taken as limiting the scope of our invention. Rather, I claim as my invention all such embodiments as may come within the scope and spirit of the following claims and equivalents thereto.

1. In a computer readable medium, a treemap visualization engine for generating treemap visualizations from arbitrary hierarchical data from a caller resource, comprising:
treemap generator object that receives an arbitrary set of hierarchical data from a caller resource and draws a treemap representation of the data; and
a treemap control object for displaying the treemap representation in a software application.

2. The visualization engine of claim 1 in which the treemap generator object includes a TreemapGenerator interface having a property that receives the set of hierarchical data as an XML string to form a collection of Node objects.

3. The visualization engine of claim 2 in which the XML string includes a <Node> element for each treemap node, the <Node> element having a child <Nodes> element that contains the child nodes of the <Node> element.

4. The visualization engine of claim 2 in which the treemap generator object further includes a Nodes interface having a method that adds an individual node object to the collection of Node objects.

5. The visualization engine of claim 1 in which the treemap generator object includes a TreemapGenerator interface having a method that draws the treemap representation of the data onto an object provided by the caller resource.

6. The visualization engine of claim 1 in which the treemap generator object further includes a Nodes interface having a method that adds an individual node object to a collection of Node objects.

7. The visualization engine of claim 1 in which the treemap control object includes a TreemapControl interface having a property that receives the set of hierarchical data as an XML string to form a collection of Node objects.

8. The visualization engine of claim 7 in which the XML string includes a <Node> element for each treemap node, the <Node> element having a child <Nodes> element that contains the child nodes of the <Node> element.

9. In a computer readable medium, a treemap visualization engine for generating treemap visualizations from arbitrary hierarchical data from a caller resource, comprising:
treemap generator object that receives an arbitrary set of hierarchical data from a caller resource and draws a treemap representation of the data, the treemap generator object including a treemap generator interface, a Nodes interface, and a Node interface; and
a treemap control object for displaying the treemap representation in an application, the treemap control object including a Treemap Control interface, a Nodes interface, and a Node interface.

10. The visualization engine of claim 9 in which the treemap generator interface includes a property that receives the set of hierarchical data as an XML string to form a collection of Node objects.

11. The visualization engine of claim 10 in which the XML string includes a <Node> element for each treemap node, the <Node> element having a child <Nodes> element that contains the child nodes of the <Node> element.

12. The visualization engine of claim 10 in which the Nodes interface includes a method that adds an individual node object to the collection of Node objects.

13. The visualization engine of claim 9 in which the treemap generator interface includes a method that draws the treemap representation of the data onto an object provided by the caller resource.

14. The visualization engine of claim 9 in which the Nodes interface includes a method that adds an individual node object to a collection of Node objects.

15. The visualization engine of claim 9 in which the treemap control interface includes a property that receives the set of hierarchical data as an XML string to form a collection of Node objects.

16. The visualization engine of claim 15 in which the XML string includes a <Node> element for each treemap node, the <Node> element having a child <Nodes> element that contains the child nodes of the <Node> element.

17. In a computer readable medium, a treemap visualization engine for generating treemap visualizations from arbitrary hierarchical data from a caller resource, comprising:
treemap generator object that receives an arbitrary set of hierarchical data from a caller resource and draws a treemap representation of the data, the treemap generator object including a treemap generator interface, a Nodes interface, and a Node interface;

18. The visualization engine of claim 17 in which the treemap generator interface includes a property that receives the set of hierarchical data as an XML string to form a collection of Node objects.

19. The visualization engine of claim 18 in which the XML string includes a <Node> element for each treemap node, the <Node> element having a child <Nodes> element that contains the child nodes of the <Node> element.

20. The visualization engine of claim 17 in which the Nodes interface includes a method that adds an individual node object to the collection of Node objects.
